(19) United States
(12) Patent Application Publication
(10) Pub. No.: US 2009/0207444 A1
(43) Pub. Date: Aug. 20, 2009

(54) Printer and control method for a printer

(75) Inventor: Akimasa Takagi, Nagano-ken (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/378,311

(22) Filed: Feb. 13, 2009

(30) Foreign Application Priority Data
Feb. 14, 2008 (JP) 2008-032793

(51) Int. Cl. G06F 3/12

(52) U.S. Cl. 358/1.15

(57) ABSTRACT

A printer enables selecting the process used for printing to the end of the print data when a no-paper state occurs during printing. The printer 1 has a resumption unit 37 that resumes the interrupted print job after a no-paper state is cleared, and a starting unit 39 that prints the print data from the beginning after a no-paper state is cleared. When a no-paper state occurs during printing, the resumption unit 37 or starting unit 39 that was set by the process content setting unit 32 operates. It is therefore possible to select the process for printing to the end after a no-paper state occurs without needing to modify the application program that runs on the external device 50 that sends the print data to the printer. Because the print data can be printed to the end regardless of which process is selected, it is also not necessary to resend the print data from the external device 50.

This application claims priority under 35 U.S.C. §119 to Japanese Patent Application No. 2008-032793 filed on Feb. 14, 2008, the entire disclosure of which is expressly incorporated by reference herein.

### BACKGROUND OF THE INVENTION

1. Field of Invention

The present invention relates to a printer and a control method for a printer that continues printing to the end of the received print data after recording paper is loaded when the recording paper supply becomes depleted during printing.

2. Description of Related Art

Printers connected to a POS register in a transaction processing system used in retail stores, for example, are one example of a printer that prints to recording paper. Roll paper is typically used as the recording paper in such printers. Printers of this type print while conveying the web of recording paper delivered from the roll paper through the transportation path passed the print head. When used for sales transaction processing, the print data for the sales information contained in one transaction generated by the POS register is received to print a receipt. If a no-paper state in which there is no paper at the print head or in the transportation path of the printer occurs while printing the print data for one transaction, this transaction processing system stops printing the receipt. In order to print the print data to the end and issue a complete receipt, the print data must be reprinted starting from the beginning after a new roll of paper is loaded and the no-paper state is cleared.

This means that whether a no-paper state has occurred in the printer must constantly be monitored from the POS register side, and if a no-paper state is detected while printing, the print data must be resent to the printer after paper is loaded and the no-paper state is cleared. However, if the POS register executes this process, the transaction processing application that runs on the POS register becomes more complicated and the cost therefore rises. Furthermore, because this also increases communication between the POS register and the printer, the load on the transaction processing application that runs on the POS register increases.

It is conceivable for the printer to store the print data received for one transaction (the print data to a break) until printing is finished so that if a no-paper state occurs during printing the buffered print data can be used to reprint from the beginning after the no-paper state is cleared. Japanese Unexamined Patent Appl. Pub. JP-A-S61-239970 teaches a printer having this function. JP-A-S61-239970 teaches a printer that interrupts printing if a no-paper state occurs during printing, and resumes the interrupted print job after the no-paper state is cleared.

Printers used in transaction processing systems must meet a wide range of user requirements, including installation requirements. This means that if the printer has only one process to execute when a no-paper state occurs, the printer may not be able to meet different user requirements.

In addition, if the process executed by the printer when a no-paper state occurs interrupts printing and then resumes printing from where printing was interrupted after the no-paper state is cleared, there will be a physical break between the portion of the receipt issued before printing was interrupted and the portion of the receipt printed after printing resumes, and there is no way of knowing that both portions belong to the same transaction.

### SUMMARY OF THE INVENTION

A printer and a control method for a printer according to at least one embodiment of the present invention enable selecting the printing process that is executed when printing resumes after a no-paper state occurs during printing.

If the process executed by the printer when a no-paper state occurs interrupts printing and then resumes printing from where printing was interrupted after the no-paper state is cleared, a printer and a control method for a printer according to another aspect of the invention enables the user to know that the printout discharged before printing was interrupted and the printout discharged after printing resumes are consecutive parts of the same print job.

A first aspect of the invention is a control method for a printer that prints to recording paper using a print head, the control method including steps of: receiving print data and storing the print data at least until printing ends; printing the print data; monitoring if a no-paper state in which there is no paper occurs before the print head; and verifying when a no-paper state occurs whether a first process or a second process is selected as the next process, and executing the process selected from among the first process and the second process. The first process includes a first printing interruption process of interrupting printing and a resumption process of resuming printing from where printing was interrupted after the no-paper state is cleared, and the second process includes a second printing interruption process of interrupting printing and a starting process of starting printing from the beginning of the print data after the no-paper state is cleared.

The printer control method according to this aspect of the invention provides a first process and a second process that can be selected as the next process to be executed by the printer when a no-paper state occurs in the printer during printing. The process to be executed by the printer can therefore be selected from among the first process and second process without modifying the application program that runs on the host device that sends the print data to the printer.

The first process includes a resumption process that resumes printing from where printing was interrupted and prints to the end of the print data after paper is loaded and the no-paper state is cleared.

The second process includes a start process that starts printing from the beginning of the print data and prints to the end after paper is loaded and the no-paper state is cleared.

Because the print data is printed to the end regardless of which process is selected, there is no need for the host device to resend the print data. Therefore, there is no need to modify the application program running on the host device, and the processing load of the application program running on the host device is not increased.

Preferably, either the first process or the second process is preselected as the process to execute if a no-paper state occurs during printing.

In order to indicate that the printout discharged from the printer was not printed completely to the end and that the printout continues when a no-paper state occurs, the control method according to another aspect of the invention preferably monitors whether a no-paper state in which there is no paper occurs before the print head is monitored. If a no-paper state occurs, a first printing interruption process interrupts printing leaving a predetermined margin at the trailing end part of the recording paper, and a first message printing process prints a predetermined first message to the predetermined margin after the first printing interruption process.

Further preferably, in order to indicate that the printout discharged from the printer after the no-paper state is cleared was not printed completely from the beginning and is the continuation of a previously printed portion, another aspect of the invention also has a second message printing process of printing a predetermined second message before the resumption process after the no-paper state is cleared.

A control method according to another aspect of the invention for a printer that prints to recording paper using a print head includes steps of receiving print data and storing the print data at least until printing ends; printing the print data; monitoring if a no-paper state in which there is no paper occurs before the print head; a first printing interruption process of interrupting printing leaving a predetermined margin at the trailing end part of the recording paper when a no-paper state occurs; a first message printing process of printing a predetermined first message to the predetermined margin; and a resumption process of resuming printing after the no-paper state is cleared.

The printer control method according to this aspect of the invention leaves white space at the trailing end part of the recording paper when interrupting printing due to a no-paper state occurring during printing, and prints a first message in this margin. This first message printed on the printout discharged from the printer when a no-paper state occurs thus enables the user to know that the printout was not completely printed to the end of the print job and continues to another printout.

Preferably, the control method also has a second message printing process of printing a predetermined second message before the resumption process after the no-paper state is cleared.

In this aspect of the invention the first message printed to the printout discharged when the no-paper state occurred and the second message printed to a separate printout discharged after the no-paper state is cleared enable knowing that the two printouts were printed based on the same batch of print data.

A control method according to another aspect of the invention for a printer that prints to recording paper using a print head includes steps of receiving print data and storing the print data at least until printing ends; printing the print data; monitoring if a no-paper state in which there is no paper occurs before the print head; a printing interruption process of interrupting printing when a no-paper state occurs; a message printing process of printing a predetermined message after the no-paper state is cleared; and a resumption process of resuming printing.

When a no-paper state occurs during printing, the printer control method according to this aspect of the invention interrupts printing, and prints a message on the recording paper before resuming the interrupted print job after paper is loaded and the no-paper state is cleared. Because a message is printed on the printout discharged from the printer after the no-paper state is cleared, the user can know that the printout was not printed completely from the beginning and is the continuation of the previously discharged printout.

Another aspect of the invention is a printer that prints to recording paper using a print head, the printer including a data storage unit that receives print data and stores the print data at least until printing ends; a data printing unit that prints the print data; a no-paper detection unit that detects if a no-paper state in which there is no paper occurs before the print head; a processing setting unit that sets a first process or a second process as the next process to be executed when a no-paper state is detected; a process confirmation unit that verifies when a no-paper state occurs whether the first process or the second process is set; a first printing interruption unit that interrupts printing when the first process is set; a resumption unit that resumes printing from where printing was interrupted after the no-paper state is cleared when the first process is set; a second printing interruption unit that interrupts printing when the second process is set; and a starting unit that starts printing from the beginning of the print data after the no-paper state is cleared when the second process is set.

The printer according to this aspect of the invention provides a first process and a second process that can be selected as the next process to be executed by the printer when a no-paper state occurs in the printer during printing, and the process setting unit sets the process to execute. The process to be executed by the printer can therefore be selected from among the first process and second process without modifying the application program that runs on the host device that sends the print data to the printer.

When the first process is selected, the resumption unit that resumes printing from where printing was interrupted when the no-paper state is cleared. If the second process is selected, the starting unit starts printing from the beginning of the print data after the no-paper state is cleared.

Because the print data is printed to the end regardless of which process is selected, there is no need for the host device to resend the print data. Therefore, there is no need to modify the application program running on the host device, and the processing load of the application program running on the host device is not increased.

In order to indicate that the printout discharged from the printer was not printed completely to the end and that there is another part to the printout when a no-paper state occurs, the first printing interruption unit interrupts printing leaving a predetermined margin at the trailing end part of the recording paper, and a first message printing unit prints a predetermined first message to the predetermined margin.

Further preferably, in order to indicate that the printout discharged from the printer after the no-paper state is cleared was not printed completely from the beginning and is the continuation of a previously printed portion, another aspect of the invention also has a second message printing unit that prints a predetermined second message on the paper after the no-paper state is cleared when the first process is selected.

Another aspect of the invention is a printer that uses a print head to print to recording paper, the printer including a data storage unit that receives print data and stores the print data at least until printing ends; a data printing unit that prints; a no-paper detection unit that detects if a no-paper state in which there is no paper occurs before the print head; a first printing stopping unit that interrupts printing leaving a predetermined margin at the trailing end part of the recording paper when a no-paper state is detected; a first message printing unit that prints a predetermined first message to the predetermined margin; and a resumption unit that resumes printing after the no-paper state is cleared.

When a no-paper state occurs during printing in a printer according to this aspect of the invention, the first printing stopping unit interrupts printing leaving a predetermined margin at the trailing end part of the recording paper, and the first message printing unit prints a predetermined first message to this margin. This first message printed on the printout discharged from the printer when a no-paper state occurs thus enables the user to know that the printout was not completely printed to the end of the print job and continues to another printout.

Preferably, the printer also has a second message printing unit that prints a predetermined second message to the recording paper after the no-paper state is cleared.

In this aspect of the invention the first message printed to the printout discharged when the no-paper state occurred and the second message printed to a separate printout discharged after the no-paper state is cleared enable knowing that the two printouts were printed based on the same batch of print data.

Another aspect of the invention is a printer that uses a print head to print to recording paper, the printer including a data storage unit that receives print data and stores the print data at least until printing ends; a data printing unit that prints; a no-paper detection unit that detects if a no-paper state in which there is no paper occurs before the print head; a printing interruption unit that interrupts printing when a no-paper state is detected; a message printing unit that prints a predetermined message to the recording paper when the no-paper state is cleared; and a resumption unit that resumes printing after the message is printed.

The printer according to this aspect of the invention interrupts printing if a no-paper state occurs during printing. When paper is loaded and the no-paper state is cleared, the message printing unit prints a message to the beginning of the recording paper, and the resumption unit then resumes printing. Because a message is printed to the printout that is discharged from the printer after the no-paper state is cleared, that the printout was not printed from the beginning of the print data, is not complete, and is a continuation of the previously discharged printout, can be known

### Effect of at Least One Embodiment of the Invention

At least one embodiment of the invention provides a first process and a second process that can be selected as the next process to be executed by the printer when a no-paper state occurs in the printer during printing. The process to be executed by the printer can therefore be selected as desired from either the first process or the second process without modifying the application program that runs on the host device that sends the print data to the printer.

The first process resumes printing from where printing was interrupted and prints to the end of the print data after paper is loaded and the no-paper state is cleared. The second process starts printing from the beginning of the print data and prints to the end after paper is loaded and the no-paper state is cleared. Because the print data is printed to the end regardless of which process is selected, there is no need for the host device to resend the print data. Therefore, there is no need to modify the application program running on the host device, and the processing load of the application program running on the host device is not increased.

In another aspect of the invention, the printer the printer leaves white space at the trailing end part of the recording paper when interrupting printing due to a no-paper state occurring during printing, and prints a first message in this margin. This first message printed on the printout discharged from the printer when a no-paper state occurs thus enables the user to know that the printout was not completely printed to the end of the print job and continues on another printout.

After a no-paper state is detected, paper is loaded and the no-paper state is cleared in another aspect of the invention, the printer prints a message to the beginning of the recording paper and then resumes the interrupted print job. Because a message is printed to the printout that is discharged from the printer after the no-paper state is cleared, that the printout is not a complete printout from the beginning of the print data and is the continuation of a printout that was already discharged can be known.

Other objects and attainments together with a fuller understanding of at least one embodiment of the invention will become apparent and appreciated by referring to the following description and claims taken in conjunction with the accompanying drawings.

### BRIEF DESCRIPTION OF THE DRAWINGS

FIG. 1A is an oblique view of the printer 1 with the cover 3 closed.

FIG. 1B is an oblique view of the printer 1 with the cover 3 open.

FIG. 2 is a schematic section view showing the internal construction of the printer 1.

FIG. 3 is a block diagram showing the control system of the printer 1.

FIG. 4 is a flow chart describing the operation of the printer 1.

FIG. 5A shows a sample of a receipt discharged from the printer 1 when a no-paper state does not occur.

FIG. 5B shows a sample of a receipt discharged from the printer 1 when a first process is selected.

FIG. 5C shows a sample of a receipt discharged from the printer 1 when a second process is selected.

### DESCRIPTION OF PREFERRED EMBODIMENTS

A preferred embodiment of a printer according to at least one embodiment of the present invention is described below with reference to the accompanying figures.

General Configuration

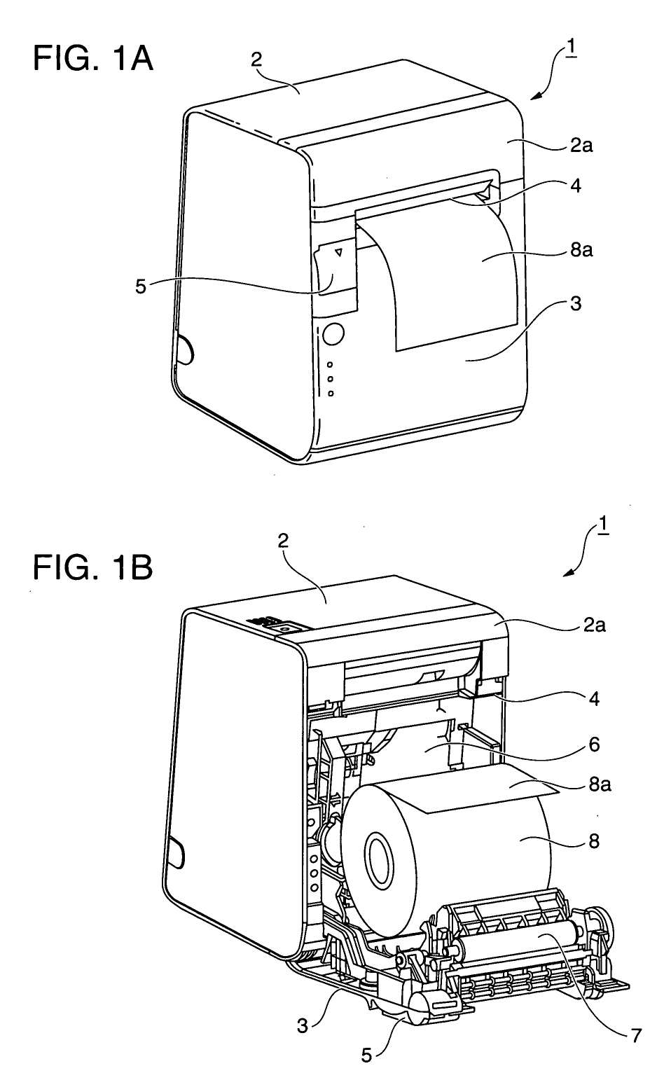

FIG. 1A is an oblique external view of a printer according to at least one embodiment of the present invention, and FIG. 1B is an oblique external view of the printer 1 with the access cover 3 open all the way.

As shown in FIG. 1A, the printer 1 has a rectangular box-like case 2 and a cover 3 that opens and closes and is disposed to the front of the case 2. A paper exit 4 of a specific width is formed at the top front of the outside case 2a part of the printer case 2. A cover opening lever 5 is disposed beside the paper exit 4. Operating the cover opening lever 5 unlocks the cover 3 so that the cover 3 can open forward to a substantially horizontal position pivoting at the bottom end part thereof below the paper exit 4 as shown in FIG. 1B.

When the cover 3 opens, the roll paper compartment 6 formed inside the case 2 is open. A platen roller 7 that defines the printing position moves at the same time with the cover 3, thus opening the transportation path from the roll paper compartment 6 to the paper exit 4 and enabling easily replacing and loading the roll paper 8 from the front of the printer.

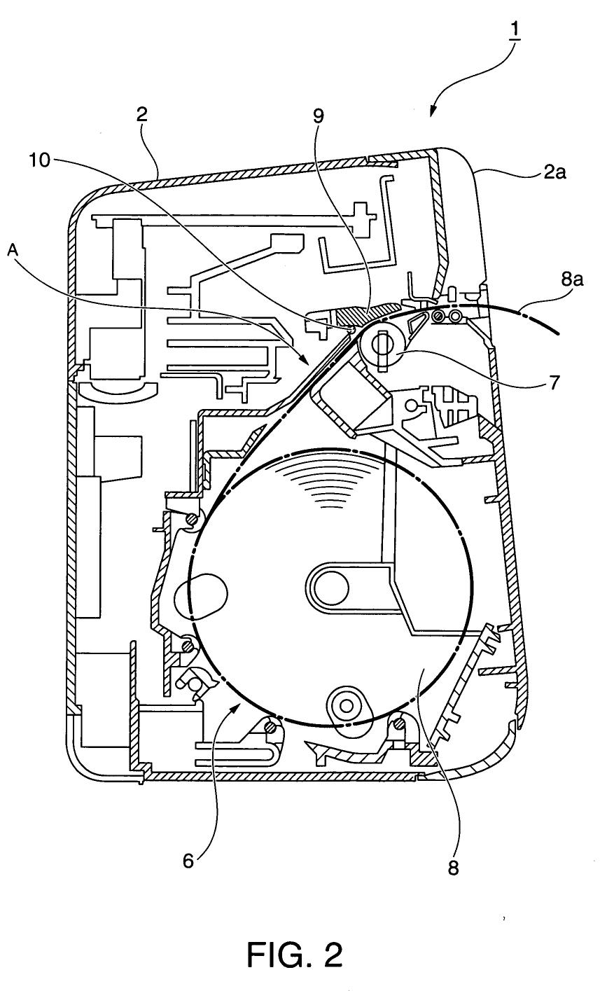

FIG. 2 is a side section view schematically showing the internal structure of the printer 1. A roll paper compartment 6 is formed inside the printer 1 in the middle between the side walls of the case 2. The roll paper 8 is loaded resting on its side widthwise to the printer inside the roll paper compartment 6.

In this embodiment of the invention the printer 1 is a thermal printer, and a line thermal head (print head) 9 extends widthwise to the printer above the roll paper compartment 6. The recording paper 8a is thermal paper in this embodiment of the invention.

When a length of recording paper 8a is pulled off the roll paper 8 and the roll paper 8 is loaded into the roll paper compartment 6 and the cover 3 is closed, the recording paper 8a is positioned through the transportation path A passed the print head 9 as shown in FIG. 2. The recording paper 8a is thus held between the print head 9 and the platen roller 7 for printing. A paper detector 10 (no-paper detector) for detecting a no-paper state in which there is no recording paper 8a on the transportation path A is disposed to the transportation path A upstream of the print head 9, that is, before the print head 9 in the transportation direction. The paper detector 10 may, for example, detect if recording paper 8a is present based on the reflection of light from the recording paper 8a conveyed through the transportation path A.

Control System

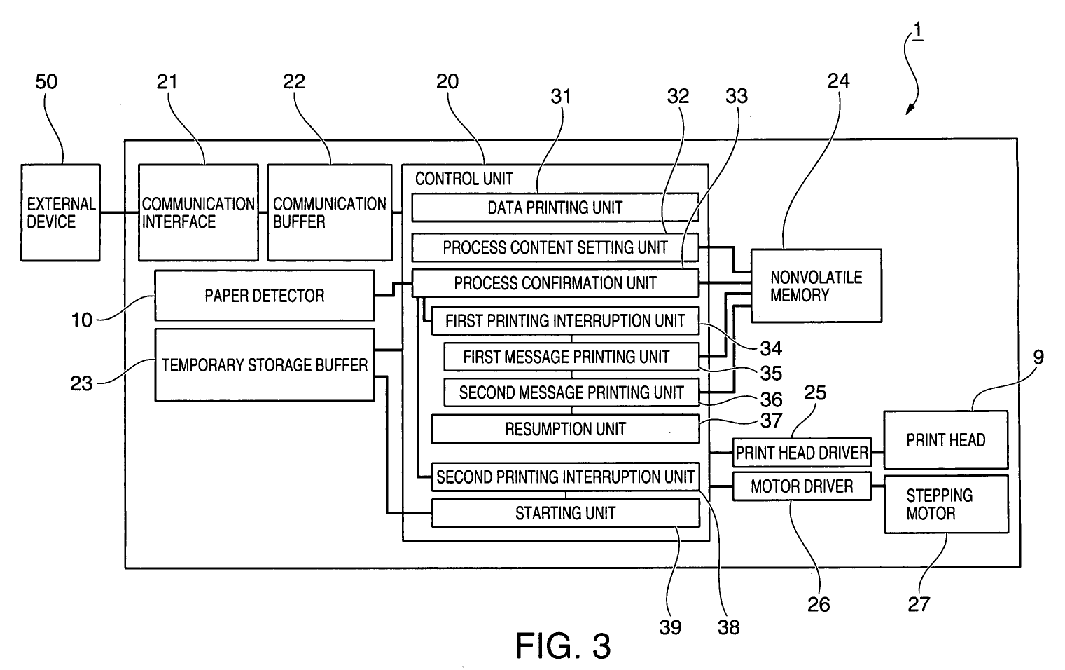

FIG. 3 is a block diagram of the control system of a printer 1 according to at least one embodiment of the present invention. The control system of this printer 1 is built around a control unit 20 including a CPU, RAM, and ROM. Print data is supplied from an external device 50 such as a PC or POS register through a communication interface 21 and communication buffer 22 to the control unit 20.

A transaction processing application that runs on the external device 50 generates transaction information during transaction processing, and sends print data in units of one transaction at a time to the printer 1 to print a receipt.

The control unit 20 includes a temporary storage buffer 23 (data storage holding unit) and nonvolatile memory 24. The temporary storage buffer 23 is RAM used to store the print data for one transaction until printing the print data is completed. The nonvolatile memory 24 stores firmware, for example, for controlling the printer 1.

The paper detector 10 is connected to the input side of the control unit 20. The thermal head 9 and paper feed stepping motor 27 are connected to the output side of the control unit 20 through a print head driver 25 and motor driver 26.

The control unit 20 includes a data printing unit 31, process content setting unit 32, process confirmation unit 33, first printing interruption unit 34, first message printing unit 35, second message printing unit 36, resumption unit 37, second printing interruption unit 38, and starting unit 39.

The data printing unit 31 controls driving the print head 9 and paper feed stepping motor 27 to print the print data.

The process content setting unit 32 sets whether the first process or second process rendered in the printer 1 executes when the printer 1 enters a no-paper state during printing. The process content setting unit 32 sets the process based on a configuration command sent from the external device 50, and the setting is stored in nonvolatile memory 24.

If the printer 1 goes to the no-paper state during printing, the process confirmation unit 33 verifies whether the first process or second process is selected for execution. More specifically, the process confirmation unit 33 reads the setting stored in nonvolatile memory 24.

When the paper detector 10 detects a no-paper state, the first process stops driving the print head 9 and paper feed stepping motor 27 and interrupts printing, and after roll paper is loaded and the no-paper state is cleared, resumes printing and prints the print data to the end. The first process is executed using the first printing interruption unit 34, first message printing unit 35, second message printing unit 36, and resumption unit 37.

The first printing interruption unit 34 interrupts printing so that white space of a predetermined length is left at the trailing end part of the recording paper 8a when the paper detector 10 detects a no-paper state on the upstream side of the transportation path A from the print head 9. More specifically, the first printing interruption unit 34 interrupts printing the print data by the print head 9 and stops conveying the paper by means of the paper feed stepping motor 27.

The first message printing unit 35 prints a predetermined first message in the predetermined margin that is formed by the first printing interruption unit 34. This first message is stored in the nonvolatile memory 24, and is read therefrom and printed by the first message printing unit 35. One example of this first message is “*to be continued*”. Once the first message is printed by the first message printing unit 35, the recording paper 8a is discharged from the paper exit 4.

The second message printing unit 36 prints a predetermined second message at the beginning of the new recording paper 8a after paper is loaded and the no-paper state is cleared. This second message is also stored in the nonvolatile memory 24, and is read therefrom and printed by the second message printing unit 36. One example of this second message is “*Restart from here*”.

Note that the first and second messages stored in the nonvolatile memory 24 may be changed to a desired message by overwriting them in nonvolatile memory 24.

The resumption unit 37 resumes printing after the second message is printed. More specifically, the resumption unit 37 drives the print head 9 and paper feed stepping motor 27 to resume printing the interrupted print job.

When no-paper state is detected by the paper detector 10, the second process stops driving the print head 9 and paper feed stepping motor 27 and interrupts printing, and after roll paper is loaded and the no-paper state is cleared, resumes printing the print data from the beginning. The second process is executed using the second printing interruption unit 38 and starting unit 39.

The second printing interruption unit 38 stops printing when the paper detector 10 detects a no-paper state on the upstream side of the transportation path A from the print head 9. More specifically, the second printing interruption unit 38 stops printing the print data by the print head 9. The paper feed stepping motor 27 is also driven a predetermined number of steps to discharge the recording paper 8a from the paper exit 4.

The starting unit 39 then prints the print data from beginning to end after roll paper 8 is loaded and the no-paper state is cleared. More specifically, the print head 9 and paper feed stepping motor 27 are controlled and driven to print the print data stored in the temporary storage buffer 23 from the beginning.

Note that the print data can be stored until printing ends in the communication buffer 22 instead of the temporary storage buffer 23.

In addition, if the process to be executed when a no-paper state occurs during printing has not been set by the process content setting unit 32, the control unit 20 stops printing if a no-paper state occurs during printing. The printer 1 then reports this no-paper state to the external device 50. The external device 50 then tells the printer 1 what process to execute in the no-paper state.

Printing Process

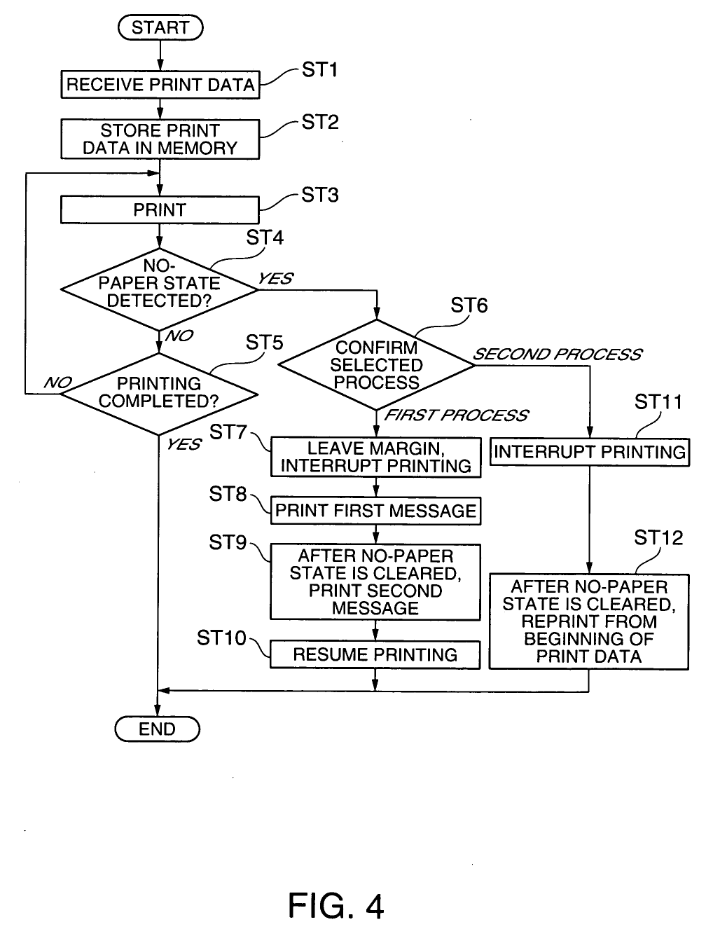

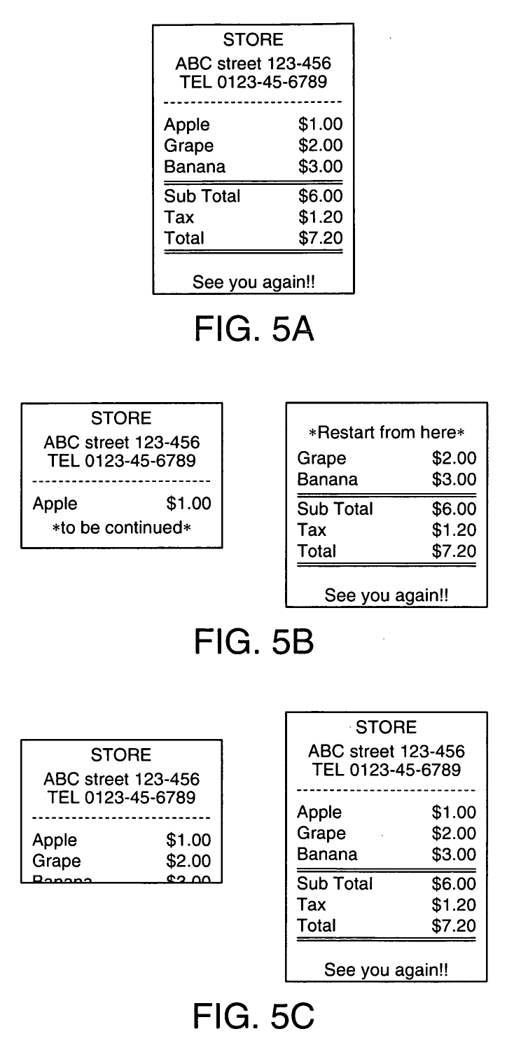

The process executed by the printer 1 when a no-paper state occurs during printing is described next with reference to FIG. 4, FIG. 5A, FIG. 5B, and FIG. 5C. FIG. 4 is a flow chart describing the operation of the printer 1, and FIG. 5A, FIG. 5B, and FIG. 5C show sample receipts output by the printer 1. FIG. 5A shows a sample of a receipt discharged from the printer 1 when a no-paper state does not occur. FIG. 5B shows a sample of a receipt discharged from the printer 1 when a first process is selected. FIG. 5C shows a sample of a receipt discharged from the printer 1 when a second process is selected.

The printer 1 in this embodiment of the invention is connected to a POS register or other external device 50, and receives batches of print data generated by the transaction process and sent from the external device 50. The printer 1 receives a setup command sent from the external device 50 and executes the first process or second process accordingly.

When the printer 1 receives a batch of print data (a print job) (ST1) the control unit 20 temporarily stores the print data in the temporary storage buffer 23 (ST2). The data printing unit 31 then prints this batch of print data (ST3).

The paper detector 10 then continues detecting if a no-paper state has occurred (ST4) until printing ends (ST5 returns No).

If printing ends (ST5 returns Yes) without step ST4 detecting a no-paper state (ST4 returns No), a receipt such as shown in FIG. 5A is printed and output. More specifically, the receipt is printed containing all information in the received print data batch, including the store name, store address, store contact information, a list of products and prices, the product subtotal, applicable taxes, and grand total, for example. When printing ends the temporary storage buffer 23 is cleared to prepare receiving the next print job.

If in step ST4 a no-paper state is detected (ST4 returns Yes), the process content setting unit 32 reads the process setting stored in the nonvolatile memory 24 and verifies if the process set by the process content setting unit 32 is the first process or second process.

If it is determined in step ST6 that the first process is set (ST6: first process), the first printing interruption unit 34 interrupts printing and leaves white space at the trailing end of the recording paper 8a (ST7). The first message printing unit 35 then prints the first message, *to be continued* (ST8).

When the no-paper state is then cleared by loading new roll paper 8, the second message printing unit 36 prints the second message, *Restart from here*, at the beginning of the recording paper 8a leader pulled from the new roll paper 8 (ST9).

The resumption unit 37 then resumes printing and prints the print data to the end (ST10). Note that the print data may also be reprinted from the beginning at this time.

A receipt as shown in FIG. 5B is output as a result of this first process. The receipt shown on the left side in FIG. 5B is the portion printed before printing was interrupted, and the receipt on the right side in FIG. 5B is the portion printed after printing resumed. The portion of the receipt printed before printing was interrupted contains a portion of the list of products and prices. By printing *to be continued* at the trailing end of this portion, the user knows that the receipt is not complete and that there is another part.

The portion of the receipt output after printing resumes starts with *Restart from here* and continues with the interrupted list of products and prices, the product subtotal and taxes, and the grand total. From the message at the top of the printed receipt the user knows that this portion of the receipt is also not complete and continues from the portion of the receipt already discharged. The user also knows that these two portions together constitute the complete receipt.

If in step ST6 the second process is set (ST6: second process), the second printing interruption unit 38 interrupts printing (ST11). When the no-paper state is cleared by loading new roll paper 8, the starting unit 39 starts printing the print data from the beginning (ST12).

This results in discharging a receipt as shown in FIG. 5C. The receipt shown on the left side in FIG. 5C is the portion printed before printing was interrupted, and the receipt on the right side in FIG. 5C is the portion printed after printing resumed. The portion of the receipt printed before printing was interrupted is thrown away, and the receipt printed after the no-paper state is cleared is a complete receipt reprinted from the beginning.

### Effect of at Least One Embodiment of the Invention

The printer 1 can selectively execute a first process or a second process if the printer 1 enters a no-paper state during printing. Either the first process or the second process can therefore be selected for execution when a no-paper state occurs without modifying the application program that runs on the POS register or other external device 50 that sends the print data to the printer 1.

The first process resumes printing and continues printing to the end after roll paper 8 is loaded and the no-paper state is cleared, and the second process reprints the print data from the beginning after roll paper 8 is loaded and the no-paper state is cleared. Because the print data is printed to the end regardless of which process is selected, the external device 50 does not need to resend the print data. It is therefore not necessary to modify the application program that runs on the external device 50, and no additional work load is added to the application program that runs on the external device 50.

Furthermore, when a no-paper state occurs the printer 1 interrupts printing to leave a blank space at the trailing end part of the recording paper 8a and prints a first message in this space. The first message recorded on the printout discharged from the printer 1 after a no-paper state occurs therefore tells the user that the printout was not printed completely to the end of the received print data, and the user knows that there is another part.

In addition, when new roll paper 8 is loaded after a no-paper state occurs and the no-paper state is cleared, a message is printed to the beginning of the new recording paper 8a and printing the interrupted print job then resumes. Because this second message is printed to the printout discharged from the printer 1 after the no-paper state is cleared, the user knows that this printout was not printed from the beginning of the print data, and knows that this printout is the continuation of the previously discharged printout.

At least one embodiment of the invention being thus described, it will be obvious that it may be varied in many ways. Such variations are not to be regarded as a departure from the spirit and scope of at least one embodiment of the invention, and all such modifications as would be obvious to one skilled in the art are intended to be included within the scope of the following claims.

What is claimed is:

1. A control method for a printer that prints to recording paper using a print head, comprising steps of:
receiving print data and storing the print data at least until printing ends;
printing the print data;
monitoring if a no-paper state in which there is no paper occurs; and
executing a process selected from among a first process and a second process,
the first process including a first printing interruption process of interrupting printing and a resumption process of resuming printing from where printing was interrupted after the no-paper state is cleared, and
the second process including a second printing interruption process of interrupting printing and a starting process of starting printing from the beginning of the print data after the no-paper state is cleared.

2. The printer control method described in claim 1, wherein:
the first process or the second process is selected before the print data is saved.

3. The printer control method described in claim 2, wherein:
the first printing interruption process interrupts printing leaving a predetermined margin at the trailing end part of the recording paper, and
includes a first message printing process of printing a predetermined first message in the predetermined margin after the first printing interruption process.

4. The printer control method described in any of claims 1 to 3, further comprising:
a second message printing process of printing a predetermined second message before the resumption process executes after the no-paper state is cleared.

5. A control method for a printer that prints to recording paper using a print head, comprising-steps of:
receiving print data and storing the print data at least until printing ends;
printing the print data;
monitoring if a no-paper state in which there is no paper occurs before the print head;
interrupting printing leaving a predetermined margin at the trailing end part of the recording paper when a no-paper state occurs;
printing a predetermined first message to the predetermined margin; and
resuming printing after the no-paper state is cleared.

6. The printer control method described in claim 5, further comprising:
a second message printing process of printing a predetermined second message before the resumption process after the no-paper state is cleared.

7. A printer that prints to recording paper using a print head, comprising:
a data storage unit that receives print data and stores the print data at least until printing ends;
a data printing unit that prints the print data;
a no-paper detection unit that detects if a no-paper state in which there is no paper occurs before the print head;
a processing setting unit that sets a first process or a second process as the next process to be executed when a no-paper state is detected;
a process confirmation unit that verifies when a no-paper state occurs whether the first process or the second process is set;
a first printing interruption unit that interrupts printing when the first process is set;
a resumption unit that resumes printing from where printing was interrupted after the no-paper state is cleared when the first process is set;
a second printing interruption unit that interrupts printing when the second process is set; and
a starting unit that starts printing from the beginning of the print data after the no-paper state is cleared when the second process is set.

8. The printer described in claim 7, wherein:
the first printing interruption unit interrupts printing leaving a predetermined margin at the trailing end part of the recording paper, and
includes a first message printing unit that prints a predetermined first message in the predetermined margin.

9. The printer described in claim 7 or 8, further comprising:
a second message printing unit that prints a predetermined second message to the recording paper after the no-paper state is cleared when the first process is set.
